(19) United States
(12) Patent Application Publication
(10) Pub. No.: US 2004/0050229 A1
(43) Pub. Date: Mar. 18, 2004

(54) Severing machine for articles of weblike material and the like having multiple blades with unloading into parallel channels

(76) Inventors: Giulio Betti, Capannori (IT); Angelo Benvenuti, Lucca (IT); Mario Gioni Chiocchetti, Capannori (IT)

Correspondence Address: Breiner & Breiner, 115 North Henry Street, PO Box 19290, Alexandria, VA, 22320-0290, US

(21) Appl. No.: 10/240,045

(22) PCT Filed: Mar. 23, 2001
(86) PCT No.: PCT/IT01/00144

(30) Foreign Application Priority Data
Mar. 28, 2000 (IT) FI2000A000077

(51) Int. Cl. B26D 7/06

(52) U.S. Cl. 83/435.2; 83/431; 83/466.1; 83/439

(57) ABSTRACT

The severing machine for the cutting of elongate products comprises a plurality of disk-shaped blades (23A) rotating about respective shafts, and a rotating feeder (11) which takes the products (L) from a loading zone (53) and feeds them to the rotating disk-shaped blades, which subdivide each product into a plurality of cut articles (R). The rotating feeder has a plurality of staggered seatings (15A, 15B, 15C) for the products, in which the products (L) are subdivided into cut articles. Two or more unloading members arranged side by side (16A, 16B, 16C) are also provided, into which the cut articles are sequentially unloaded.

### TECHNICAL FIELD

The present invention relates to a severing machine for cutting rolls or logs of great length into a plurality of small rolls intended for final consumption, or for cutting other elongate products, especially of weblike material, for example packs of paper napkins or other interleaved articles.

Machines of this type are commonly used in the paper processing industry for the production of rolls of toilet paper, rolls of kitchen paper and the like or other paper articles.

### STATE OF THE ART

In the paper converting industry, and especially in the production of products made of so-called tissue paper, provision is commonly made for the weblike material to be wound up into logs or rolls of large axial dimensions and diameter equal to the diameter of the finished article. These logs or rolls are subsequently cut into a plurality of small rolls, of axial dimensions equal to the final dimension of the article intended for consumption, by means of severing machines.

Typically, in order to perform the cutting of the rolls, use is made of severing machines which possess an assembly rotating or oscillating about a shaft and on which are mounted one or more disk-shaped blades controlled in rotation about their respective axes. The movement of the assembly brings the disk-shaped blade(s) mounted thereon to penetrate cyclically into the material forming the roll, which is caused to advance below the rotating assembly. At each cycle of the rotating assembly, at least one small roll is cut from one of the rolls being fed. Normally, a plurality of rolls are caused to advance in parallel and are cut simultaneously with successive passages of the same disk-shaped blade carried by the rotating or oscillating assembly. When the assembly carries two blades, two cuts are made during each cycle.

An example of a severing machine of this type is described in

According to another known technology, provision is made to cut each roll into the final number of small rolls in a single pass by means of a series of parallel cutting blades. A severing machine of this type is described in U.S. Pat. No. 4,329,895. In this machine, the rolls to be cut are inserted into cradles which advance in a linear manner below a plurality of parallel rectilinear blades inclined relative to the direction of advance of the rolls. The blades all penetrate together and gradually into the material of the roll, cutting the latter into a series of small rolls during a single pass.

Another example of a severing machine which allows the simultaneous cutting of each roll into a plurality of small rolls is described in IT-B-1 103 635. In this known machine, a rotating assembly presents the individual rolls, which are accommodated in respective seatings, to a set of rotating blades. The rotating blades have a shape such as to penetrate gradually with their cutting edges into the thickness of the rolls. From the rotating assembly—which is fed with intermittent motion—the small rolls are unloaded into an individual duct which, by means of a complex kinematic mechanism, in turn delivers the small rolls to one or the other, in turn, of the two outward conveyors. The device is complex and slow.

The known multiple severing machines are not sufficiently efficient to meet current high productivity requirements. At present, therefore, preference is given to systems which perform the cutting of the rolls in successive operations of “slicing” the rolls.

Moreover, the multiple-cutting machines known today are complex and bulky, and do not meet present-day safety standards.

### OBJECTS AND SUMMARY OF THE INVENTION

It is an object of the present invention to provide a severing machine having multiple blades which operate simultaneously, in other words capable of cutting in a single operation a plurality of small rolls or other articles from a single roll or other elongate product, which is more efficient and which is capable of meeting the current requirements of high production speed. This is necessary in order to ensure that the severing machine can keep pace with the high speed of production of the upstream machinery, in particular the rewinding machines, and the downstream packaging machines.

These and other objects and advantages, which will become clear to the person skilled in the art from reading the text that follows, are achieved by a severing machine comprising a plurality of rotating disk-shaped blades and a product feeder which takes the products to be cut from a loading zone and presents them in the cutting zone, and which subdivides each product into a plurality of cut articles. The feeder is rotating (with a continuous or intermittent motion) about an axis of rotation and possesses a plurality of seatings in which the products are arranged and in which said products are cut into individual articles. The machine comprises two or more unloading members arranged side by side, where the rotating feeder rapidly releases the cut articles.

The cut articles obtained by cutting a single product, for example a roll or log, are therefore unloaded alternately into one or the other of a plurality of unloading members for subsequent rapid transfer of the cut articles to the downstream machinery, in particular to the packaging machinery.

Since the machine possesses a plurality of unloading members arranged side by side to which the rotating feeder releases the cut articles in sequence, the removal of the released articles in each unloading member may take place over longer periods and therefore at lower speeds than those that would be necessary in the case where all the articles were released by the rotating feeder into a single unloading member. This makes it possible, first, to achieve very high cutting speeds (and hence a very high number of articles per unit of time), and secondly prevents the cut articles in the unloading members undergoing an excessive acceleration which could result in a distortion of their alignment and hence a subsequent blocking of the lines downstream.

In fact, one of the limitations of the multiple-blade severing machines currently known is represented by the fact that they cannot exceed those speeds at which the removal of the cut small rolls would result in their overturning as a result of the abrupt accelerations undergone in the unloading channel.

When unloading takes place alternately into a plurality of adjacent members, the speed of removal of the articles in each unloading member or in an unloading channel downstream thereof can be equal to a fraction of that which would be necessary in the case of a single unloading member. Typically, for example, using three unloading members arranged side by side, each formed by an unloading channel with which is associated an outward conveyor for the articles, the speed of removal in each channel can be equal to one third of that necessary in the case of a single unloading channel. Setting the speed of removal as equal to a limit speed lower than that which can cause accidental upsetting of the articles as a result of excessive acceleration, the severing machine can cut the products with three times the speed by comparison with the limit speed.

According to a possible embodiment, the unloading members are formed by a plurality of unloading channels with which is associated an outward conveyor. In this case, the rotating feeder unloads the cut articles directly and sequentially once into one and once into the other of the unloading channels. The outward conveyor may be a single conveyor having a width such as to extend across all the channels, or each channel may be equipped with its own outward conveyor.

According to this embodiment of the invention, the rotating feeder is sequentially aligned so as to unload the articles from each of its seatings in succession into the various unloading channels, in other words in a manner such that consecutive seatings of the rotating feeder release the cut articles contained therein into adjacent unloading channels. In this manner, a particularly compact configuration is obtained, with a limited number of moving parts of the machine.

In this configuration, provision may advantageously be made, in the interests of regularity of operation, for the rotating feeder to interact alternately and in succession with a plurality of loading positions, equal in number to the number of unloading channels. This is particularly useful in the case of intermittent rotation of the feeder. If the latter rotates with continuous motion, it is preferable to provide a single loading position.

In each loading position, the products to be cut are fed, for example, from a storage unit comprising a flexible member with which are associated oscillating cradles where the individual products are accumulated. The oscillating cradles can unload the products directly into the seatings of the rotating feeder of the severing machine. Alternatively, for a more precise control of the movements of the products in the machine, a distributor may be provided in each loading position, which receives individual products from the cumulative storage unit and transfers them to the rotating feeder.

In a different form of embodiment, the unloading members may comprise a plurality of mobile cradles arranged between the rotating feeder and respective unloading channels equipped with an outward conveyor or conveyors. In this case, the rotating feeder sequentially releases the small rolls or other articles obtained from the cutting of each roll or other product into respective adjacent mobile cradles and the latter transfer them to the unloading channels. The transfer movement of the cut articles from the mobile cradles to the unloading channels is controlled in a manner such that series of small rolls or other articles coming from successive seatings of the rotating feeder are unloaded into different unloading channels, so that in this case also the possibility is obtained of removing the articles from the individual channels at reduced speeds and maintaining the working speed of the severing machine at high levels.

In order to retain the rolls or other products to be cut and, after cutting, the small rolls or other cut articles in the seatings of the rotating feeder, retaining members may be provided that rotate together with the feeder and are associated with each seating of the latter. Alternatively, a continuous flexible retaining member may be provided, passing around pulleys or cylinders in a fixed position and interacting with the rotating feeder in the cutting zone to retain the products during cutting and, subsequently, the cut articles until the latter are subsequently released into the unloading channels.

The continuous flexible member moves along a closed path defined by a series of pulleys at a speed equal to the peripheral speed of the rotating feeder. However, the shafts of the pulleys remain fixed and do not move with the rotating feeder. In this sense, the retaining member may be said to be arranged in a fixed position.

The invention further relates to a method for cutting rolls of weblike material, or other elongate products, into small rolls or other articles, in which a product to be cut is fed to a plurality of cutting blades and cut simultaneously into a series of articles and in which series of articles that are obtained from products fed in succession are subsequently released into unloading members arranged side by side.

Further advantageous features of the severing machine and of the method according to the invention are indicated in the attached claims.

### BRIEF DESCRIPTION OF THE DRAWINGS

The invention will be better understood with reference to the description and the attached drawing, which shows a practical, non-limiting embodiment of said invention applied to a severing machine for rolls of weblike material, for the subdivision of rolls into small rolls of length equal to the length of the finished article. In the drawing:

FIG. 1 shows a diagrammatic lateral view of the severing machine under working conditions;

FIG. 2 shows, in a lateral view, an intermediate phase of cutting blade exchange;

FIG. 3 shows a lateral view along the line III-III in FIG. 1;

FIGS. 4, 5 and 6 show successive working phases of the severing machine;

FIG. 7 shows a lateral view analogous to that in FIG. 1 in a different embodiment;

FIGS. 8A-8E show successive operating phases of the machine in the configuration according to FIG. 7.

### DETAILED DESCRIPTION OF THE PREFERRED EMBODIMENTS OF THE INVENTION

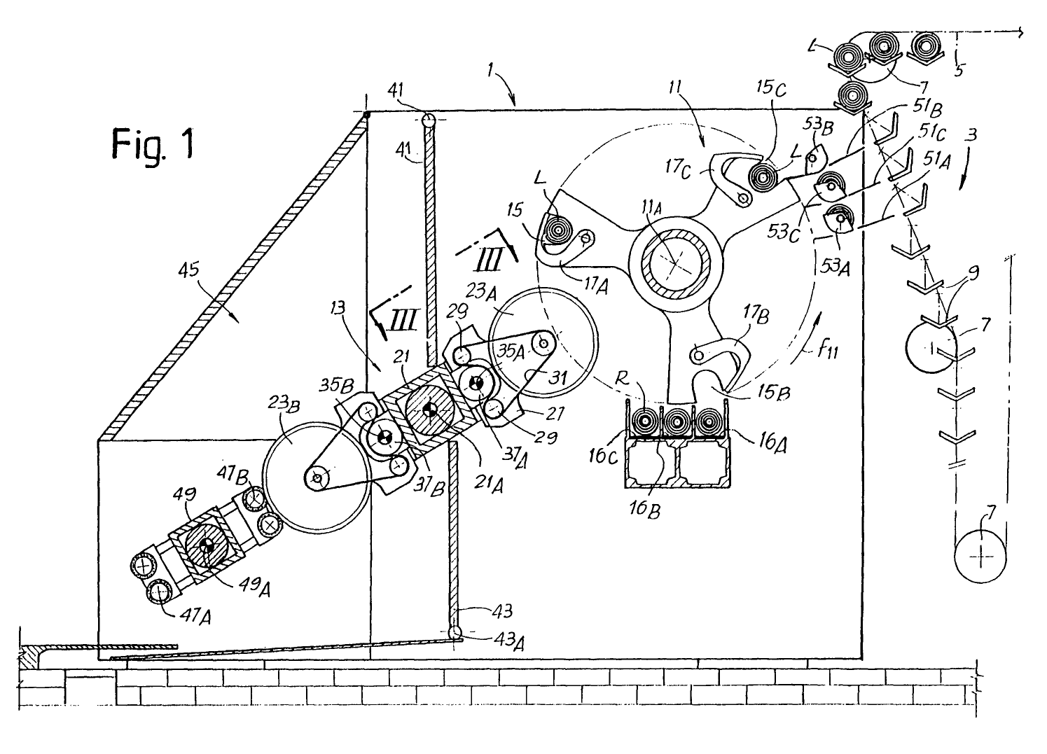

Referring first to FIGS. 1, 2 and 3, a description will be given of the basic components of the machine in a first embodiment.

The severing machine, generally designated 1, is fed with series of rolls or logs L by a storage unit 3 arranged on one side of the machine. The storage unit 3 comprises a flexible member 5 passed around a series of pulleys 7 and bears a plurality of oscillating cradles 9, which unload the logs L to loading positions in the severing machine, in a manner that will be described below. The storage unit 3 is of a type known per se and will not be described in more detail. It may be replaced by any other system for feeding the logs to be cut.

The severing machine 1 has a rotating feeder 11 which takes the incoming rolls L and presents them to a cutting unit 13. In the example shown in FIGS. 1 to 6, the rotating feeder 11 is constituted by an assembly rotating about a horizontal shaft 11A and is equipped with three seatings 15A, 15B and 15C, arranged at steps at 120° relative to one another about the axis of rotation 11A. The seatings 15 may be adaptable (with inserts or the like) to the dimensions of the roll. Associated with each seating 15A, 15B, 15C is a respective retaining member 17A, 17B and 17C. The retaining members 17A, 17B and 17C serve to secure the logs or rolls L in the respective seatings 15A, 15B, 15C during cutting, in a manner which will be described below.

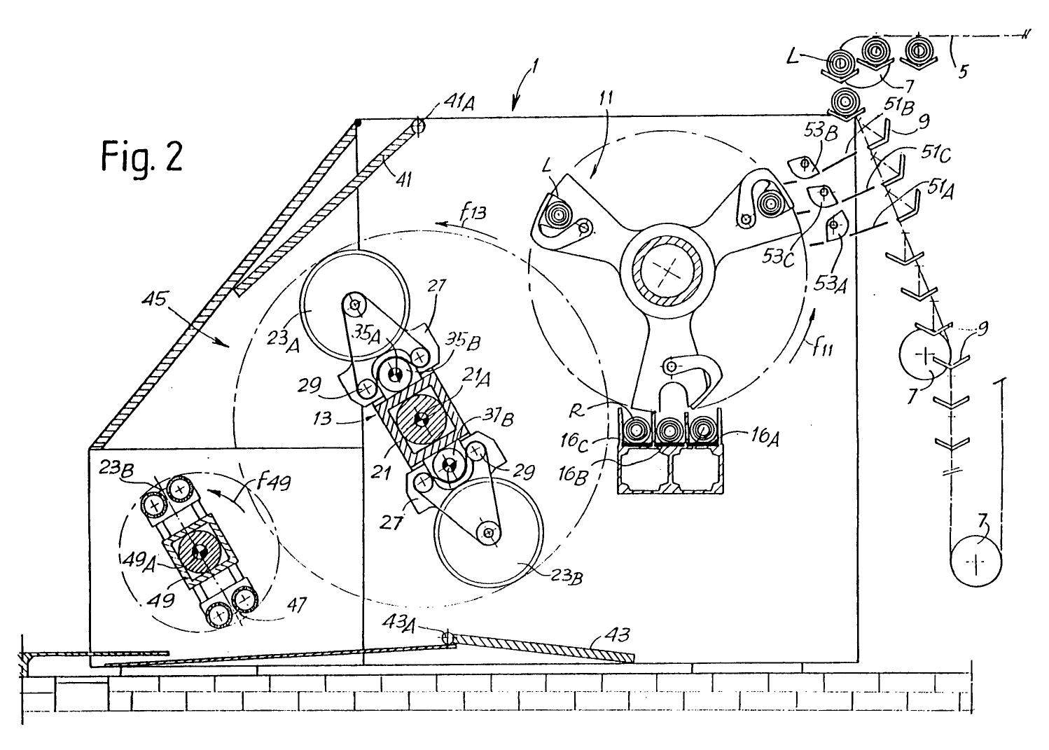

Below the rotating feeder 11 are arranged three unloading members, formed in this example of embodiment by the same number of unloading channels designated 16A, 16B and 16C respectively. Within each unloading channel is arranged a conveyor belt or other means for removing the small rolls, which moves in the direction orthogonal to the plane of the drawing in FIGS. 1 and 2. The number of channels 16 and the number of seatings 15 may be different from one another.

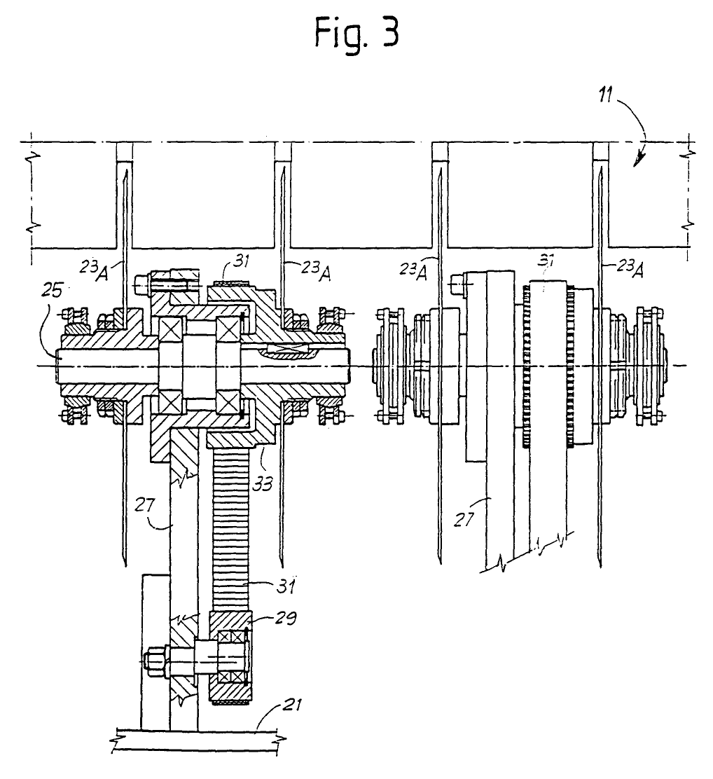

The cutting unit 13 comprises a support 21 formed by a horizontal beam rotating or oscillating about a horizontal axis 21A. The support 21 bears two series of rotating disk-shaped cutting blades, designated 23A and 23B. The two series of disk-shaped blades 23A and 23B are mounted symmetrically on the support 21 and only one of them will be described in detail with reference, in particular, to FIG. 3. The blades of each series rotate about a respective common axis of rotation. It must be understood, however, that the axes of the various blades of each series may also be slightly staggered and/or may have slightly different orientations, in other words not be parallel.

The rotating disk-shaped blades 23A are mounted in pairs (FIG. 3), each pair being supported by a spindle 25 mounted on a respective bracket 27. Mounted on the bracket 27 are two toothed drive pulleys 29 for a toothed belt 31, which is in turn driven about a third toothed pulley 33 made integrally on a support of one of the blades 23A of each pair and torsionally linked to the shaft 25. For each series of disk-shaped blades 23A, 23B, a common driveshaft 35A, 35B is mounted on the support 21, on which driveshaft drive pulleys 37A, 37B are splined which supply the motion to the toothed belt 31 of each pair of blades 23A, 23B. A preferably dual motor drive, or one having suitable clutches (not shown), causes the two driveshafts 35A and 35B to rotate independently of one another.

As can be seen in FIGS. 1 and 3, the blades 25A, 25B and the respective belts 31 are mounted on the brackets 27, and the latter are mounted relative to the support 21 and to the pulleys 37A, 37B in a manner such that each pair of blades and associated supports may be easily removed and refitted without the need to remove and refit the belts 31.

Two walls 41, 43 interact with the support 21 and oscillate about horizontal axes 41A and 43A, parallel to the axis 21A of rotation or oscillation of the support 21. The walls 41 and 43 may assume the position shown in FIG. 1, in which, together with the support 21, they define a barrier which separates the cutting zone, where the cutting of the rolls or logs L into small rolls takes place, from the sharpening zone, generally designated 45. In the latter, other operations may also be performed, for example those of maintaining and/or washing the blades.

In the sharpening zone 45 are located a first sharpening group 47A and a second sharpening group 47B. The two sharpening groups 47A and 47B are each formed by pairs of sharpening wheels, each associated with one of the rotating disk-shaped blades 23A, 23B of the two series of disk-shaped blades. The two sharpening groups 47A and 47B are carried by a common rotating or oscillating assembly 49 mounted about a horizontal axis 49A, parallel to the axis 21A of the support 21 of the series of disk-shaped cutting blades 23A and 23B. The positions of the wheels of the groups 47A and 47B can be independently adjusted and each group follows the wear of the blade of the respective series. The regulation of the position and the recovery of wear take place in a manner known per se.

The machine described hitherto operates as follows.

The rolls or logs L are unloaded in alternation onto three unloading chutes 51A, 51B and 51C, with each of which is associated a rotating distributor 53A, 53B and 53C respectively. The rotating feeder 11 sequentially removes a log or roll L from one or other of the loading positions defined by the chutes 51A, 51B and 51C and by the distributors 53A, 53B and 53C, in a manner and for the purposes which will be described in greater detail below.

Each roll L is received in one of the seatings 15A, 15B and 15C of the rotating feeder 11 and secured there by means of the respective retaining members 17A, 17B or 17C. By means of a counterclockwise rotation in the direction of the arrow f11, the rotating feeder 11 carries each roll L in front of the cutting unit 13. As can be seen in FIG. 1, the position of the seatings 15A, 15B and 15C relative to the disk-shaped blades 23A (or alternatively 23B) is such as to ensure that the latter penetrate gradually, with the rotation of the rotating feeder 11, into the wound-up weblike material which forms the roll L. For this purpose, the seatings 15A, 15B and 15C have appropriate cuts which allow the passage of the disk-shaped cutting blades 23A and 23B (FIG. 3). Similarly, the retaining members 17A, 17B, 17C are spaced so as not to interfere with the rotating disk-shaped blades 23A, 23B.

The disk-shaped blades 23A or 23B are arranged in a number and position such as simultaneously to cut a roll L into the desired final number of small rolls, and further to cut two trims, head and tail, which are scrapped in a manner known per se.

The two series of rotating disk-shaped blades 23A and 23B operate in alternation. In the configuration shown in FIG. 1, the series of disk-shaped blades 23A is in operation, while the series of blades 23B is located in the sharpening zone 45 and is being subjected to sharpening by means of the sharpening group 47B.

When it is necessary to discontinue operation with the disk-shaped blades of series 23A and initiate operation with the series of disk-shaped blades 23B, the two walls 41A and 41B are opened and the support 21 is rotated through 180°. FIG. 2 shows an intermediate phase of the movement by which the series of blades 23A and 23B exchange position.

During this exchange operation, the support assembly 49 also rotates, so that when the blades 23A arrive in the sharpening zone 45, the sharpening wheels 47A interact therewith.

With this method of operation, it is possible to carry out the sharpening of the blades in a zone which is completely isolated from the cutting zone and over a period that may be protracted insofar as it is in any case in the background relative to the cutting operations which are being performed by the blades currently in operation.

Since the series of blades 23A and 23B may have undergone different degrees of wear, the use of independent sharpening groups 47A and 47B for the two series of disk-shaped blades 23A and 23B makes it possible to relocate, during each sharpening cycle, the exact relative position between sharpening wheels and associated disk-shaped cutting blades.

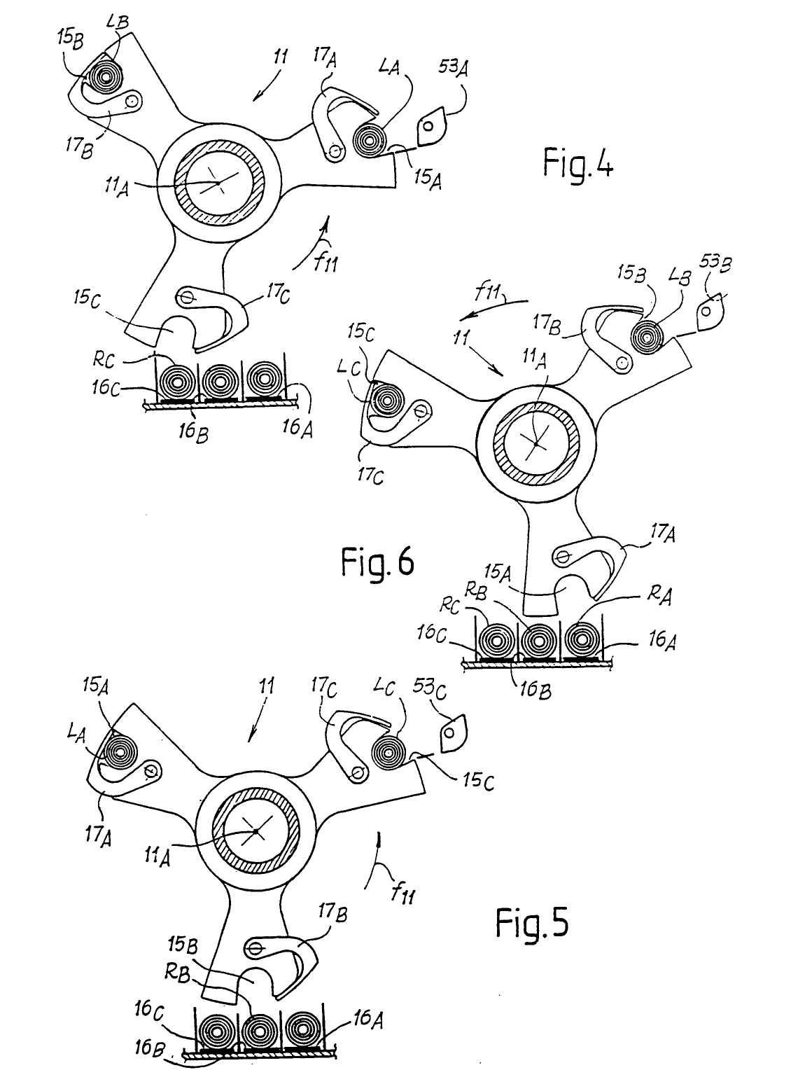

With reference to FIGS. 4, 5 and 6, a more detailed description will now be given of the unloading and removal system for the cut small rolls. The individual seatings 15A, 15B and 15C unload the small rolls contained therein, obtained by the cutting of the logs or rolls L by means of the disk-shaped blades 23A or 23B, each into one of the unloading channels 16A, 16B and 16C arranged side by side. In this manner, it is possible to remove the small rolls from the individual channels 16A, 16B and 16C at a removal speed equal to one third of that which would be necessary if the small rolls were transferred from the feeder 11 into a single unloading channel. In this manner, it is possible to maintain a high cutting speed without it being necessary to remove the small rolls from the individual channels 16A, 16B and 16C at such a high speed as to risk causing the upsetting thereof and consequent problems in the subsequent packaging operations.

In FIG. 4, the rotating feeder 11 is located in an angular position such as to ensure that the seating 15C is aligned with the unloading channel 16C. The retaining member 17C is opened to allow the release of the series of small rolls RC (obtained by cutting the roll previously inserted into the seating 15C) into the unloading channels 16C.

At the same time, the seating 15A is at the loading position defined by the chute 51A and by the rotating or oscillating distributor 53A. The latter removes a log LA from the chute 51A and transfers it into the seating 15A where it is secured by means of the retaining member 17A. The seating 15B is located in proximity to the operating zone of the rotating disk-shaped blades 23A and contains a roll LB secured in the seating by the retaining member 17B.

Rotating counterclockwise in the direction of the arrow f11, the rotating feeder 11 passes from the position shown in FIG. 4 to the position shown in FIG. 5. In this position, the seating 15B is located at the unloading channel 16B. The rotation has caused the penetration of the cutting blades through the roll LB and hence its subdivision into small rolls RB. The retaining member 17B is opened to allow the release of the small rolls RB obtained from the log LB into the unloading channel 16B. The seating 15C from which the small rolls RC are unloaded into the channel 16C is now at the loading position defined by the chute 51C and by the rotating distributor 53C. The latter removes a new roll LC from the chute 51C and inserts it into the seating 15C, where it is secured by the retaining member 17C. The seating 15A with the roll LA secured within it by means of the retaining member 17A is approaching the zone of operation of the rotating disk-shaped blades 23A. In this phase, the small rolls RC released from the seating 15C into the channel 16C have begun moving away in the axial direction.

After a further rotation of the rotating feeder 11, the latter is located in the position shown in FIG. 6. In this position, the seating 15A is at the unloading channel 16A and the retaining member 17A opens to permit the release of the small rolls RA (obtained by the simultaneous cutting by means of the blades 23A of the log LA) into the unloading channel 16A. The seating 15B has in the meantime reached the loading position defined by the chute 51B and by the rotating distributor 53B. The latter takes a roll LB from the chute and transfers it into the seating 15B where it is secured by means of the retaining member 17B. The roll LC, retained in the seating 15C, is approaching the series of disk-shaped blades 23A in order to be subdivided into a series of small rolls RC, which will be released into the unloading channel 16C once the rotating feeder 11 has again reached the position shown in FIG. 4. The small rolls RB released into the channel 16B have already begun the movement away.

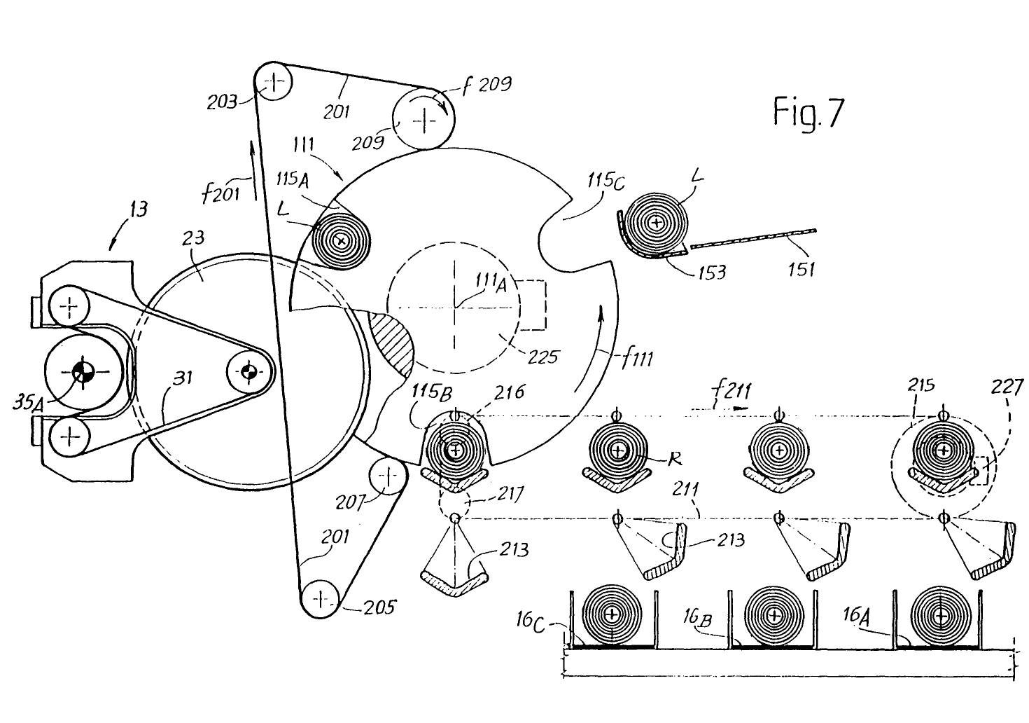

FIG. 7 shows, in a lateral view analogous to that of FIG. 1, a different form of embodiment of the severing machine according to the invention. Identical numbers indicate parts identical or corresponding to those previously described. In particular, there is substantially no change in the complex comprising the cutting unit 13, the sharpening zone 45 and the sharpening groups 47A, 47B and the associated accessories.

The rolls or logs L coming from the storage unit 3 or other feed system are taken from a rotating feeder 111, which rotates (with continuous or intermittent motion) about a horizontal axis 111A. The rotating feeder 111 has a cylindrical development, along which are formed three seatings 115A, 115B and 115C. Each seating 115A, 115B and 115C receives the rolls or logs L from a rotating or oscillating distributor 153 which takes them from a chute 151 associated with the storage unit 3. The feeder 111 also possesses annular grooves for the passage of the blades, visible in the zone shown in section.

The rotating feeder 111 is encompassed, over an appropriate arc and on the side facing the cutting unit 13, by a plurality of belts or equivalent continuous flexible members, designated 201. Only one of said belts is visible in the drawing, the others being arranged along the same path and therefore behind that shown in the drawing, at appropriate distances so as not to interfere with the cutting blades.

The belts 201 are passed around wheels or pulleys 203, 205, 207 and 209 with fixed axes. The retaining member formed by the belts 201 is therefore fixed relative to the rotating feeder 111, in the sense that the latter remains in the same spatial position, although moving along the transmission path defined by the pulleys and the rotating assembly.

As is clearly apparent in FIG. 7, the belts 201 constitute a retention system which retains each roll L fed by the rotating feeder 111 to the cutting unit 13 for the entire period necessary to perform the cutting of the rolls L into small rolls R and until the unloading position is reached.

Arranged below the rotating feeder 111 is a flexible member 211 which bears a plurality of oscillating cradles 213 which are movable along the closed path defined by said flexible member 211, passed around wheels 215, 216 and 217. Below the system of mobile oscillating cradles 213 are arranged three unloading channels 16A, 16B and 16C, equipped with respective outward conveyor belts. The oscillating cradles 213 constitute, in this embodiment, the unloading members of the machine, arranged side by side.

With this configuration, as will be clarified below, the small rolls transported by the rotating feeder 111 are released after cutting to the oscillating cradles 213 and released from there in threes into the three unloading channels 16A, 16B and 16C, so that the conveyor belts within the latter can move at a speed one third of that which would be necessary to remove all the small rolls if the latter were unloaded into a common channel.

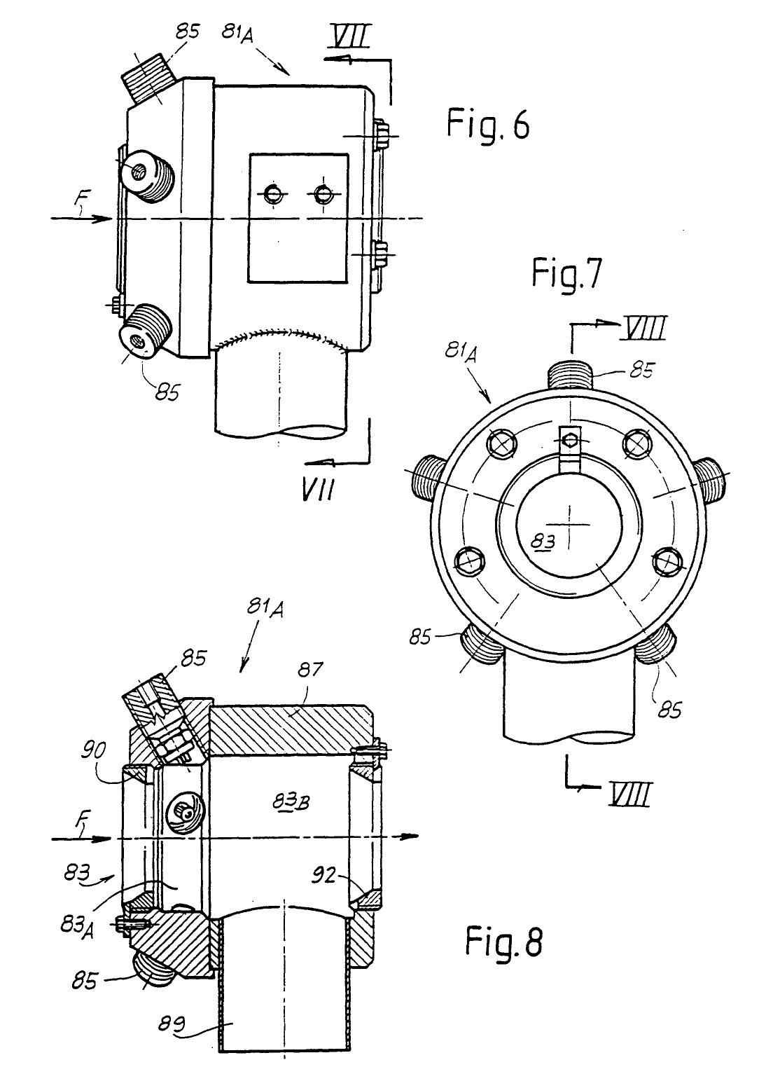

FIGS. BA through 8E show the operating sequence in a possible form of embodiment. As is apparent by comparing the sequence of positions shown in FIG. 8, the rotating feeder 111 unloads the various series of cut small rolls R successively into the various cradles 213. The latter are caused to advance stepwise in a manner such as to present an empty cradle on each occasion below the seating 115A, 115B or 115C. The full cradles 213, in other words those that contain the cut small rolls R, are transferred stepwise from the upper strand of the flexible member 211 to the lower strand thereof, in alignment with the unloading channels 16A, 16B and 16C. Once three full cradles 213 are located above the three unloading channels 16A, 16B and 16C, the latter are simultaneously caused to oscillate in order to release the three series of small rolls R into the unloading channels 16A, 16B and 16C, where the respective conveyor belts remove said small rolls in a direction orthogonal to the plane of the figure.

It will be understood that the movements of the cradles 213, of the flexible member 211 and of the rotating feeder 111 can also be differently phased, the distances between the cradles 213 on the flexible member 211 being modified as appropriate.

In the example shown, the rotating feeder 111 is caused to rotate by a motor 225 which transmits the motion to the belts 201, which may or may not be toothed, in order to interact with a corresponding peripheral toothing of the feeder 111.

A second motor 227 supplies the-motion to the wheel 215 and thence to the flexible member 211. The two motors 225 and 227 are synchronized with one another in order to obtain the correct transfer of the rolls L, for example by means of an electronic control. The possibility of a mechanical connection, for example by means of an intermitter or a mixed linkage, for example using epicycloidal gears and correcting motors, is not ruled out.

In all the forms of embodiment, the rotating feeder may be controlled with a continuous rotational motion by virtue of the use of multiple unloading members arranged side by side. This makes it possible to achieve high speeds and a regular operation, without severe stresses.

It is understood that the drawing shows only a simplification, provided solely by way of a practical demonstration of the invention, the latter being capable of being varied in shapes and arrangements without thereby departing from the scope of the idea underlying said invention.

1. A severing machine for the cutting of elongate products, comprising a plurality of disk-shaped blades rotating about respective shafts, and a rotating feeder which takes the products from a loading zone and feeds them to the rotating disk-shaped blades, which subdivide each product into a plurality of cut articles, wherein said rotating feeder has a plurality of staggered seatings for said products, in which said products are subdivided into cut articles, and wherein two or more unloading members are provided side by side, said rotating feeder releasing the cut articles sequentially into said unloading members.

2. Machine as claimed in claim 1, wherein said rotating feeder and said rotating disk-shaped cutting blades are disposed in a manner such that the rotational movement of the rotating feeder causes the gradual penetration of the disk-shaped blades into the rolls to be cut.

3. Machine as claimed in claim 1 or 2, wherein said unloading members are formed by unloading channels equipped with an outward conveyor which removes the cut articles released into said channels, and wherein said feeder releases said cut articles directly into said unloading channels.

4. Severing machine as claimed in claim 3, wherein said rotating feeder is sequentially directed in a manner such that said seatings release the cut articles contained therein sequentially into adjacent unloading channels.

5. Severing machine as claimed in claim 3 or 4, wherein said feeder comprises, for each seating, a retaining member for holding the products to be cut and the cut articles in the respective seating, and wherein each of said retaining members is opened to release the cut articles from the respective seating in a different angular position of the rotating feeder, into a respective unloading channel.

6. Severing machine as claimed in one or more of claims 3 to 5, comprising a plurality of loading positions, equal in number to the number of unloading channels, the rotating feeder taking said products to be cut from said loading positions alternately.

7. Severing machine as claimed in claim 6, wherein a distributor of products to be cut is arranged in each loading position.

8. Severing machine as claimed in claim 1 or 2, wherein said unloading members comprise a plurality of mobile cradles arranged between the rotating feeder and unloading channels arranged side by side and equipped with an outward conveyor to remove the cut articles released into the unloading channels, and wherein a plurality of mobile cradles containing respective cut articles are unloaded in order to release the cut articles into the unloading channels arranged side by side.

9. Severing machine as claimed in claim 8, wherein said rotating feeder sequentially releases cut articles into said mobile cradles and wherein groups of said mobile cradles simultaneously release the cut articles into said unloading channels.

10. Machine as claimed in claim 8 or 9, wherein said mobile cradles are carried by a continuous flexible conveyor and move along a closed path having an upper length and a lower length, with the cradles receiving the cut articles released by the rotating feeder along the upper length and said cradles being positioned along the lower length to transfer the cut articles into said unloading channels.

11. Severing machine as claimed in claim 8, 9 or 10, comprising a retaining member formed by at least one flexible continuous member, partially passed around said rotating feeder, to retain the products during cutting.

12. Machine as claimed in one or more of the preceding claims, in which said rotating feeder rotates in continuous motion.

13. Method for cutting elongate products into cut articles, wherein each product is moved by means of a rotating feeder from a loading position to a cutting position, in which it is subdivided into cut articles by means of a plurality of disk-shaped cutting blades, and the cut articles are moved by said rotating feeder from the cutting position to a release position where they are released sequentially by said rotating feeder into unloading members arranged side by side.

14. Method as claimed in claim 13, wherein successive series 9 of cut articles are released in unloading positions offset angularly along said circular path.

15. Method as claimed in claim 13 or 14, wherein said products are moved by a feeder rotating about an axis substantially parallel to the axis of rotation of the disk-shaped cutting blades, and wherein the rotating feeder and the rotating disk-shaped cutting blades are arranged in a manner such that the rotation of the rotating feeder causes the penetration of the disk-shaped blades into the products to be cut.

16. Method as claimed in one or more of claims 13 to 15, wherein a plurality of said unloading members releases the cut articles into a corresponding plurality of unloading channels.
